(19) United States
(12) Patent Application Publication
(10) Pub. No.: US 2016/0337058 A1
(43) Pub. Date: Nov. 17, 2016

(54) TRANSMISSION METHOD AND SYSTEM FOR GROUPCAST MESSAGE AND STORAGE MEDIUM ACCESSIBLE BY ELECTRONIC DEVICES

(71) Applicant: GEMTEK TECHNOLOGY CO., LTD., HSINCHU (TW)

(72) Inventors: CHUNG-CHIU LAI, HSINCHU (TW); CHIA-MENG CHEN, HSINCHU (TW)

(21) Appl. No.: 14/849,221

(22) Filed: Sep. 9, 2015

(30) Foreign Application Priority Data
May 13, 2015 (CN) 201510242127.9

(51) Int. Cl. H04H 20/08; H04W 8/14; H04W 40/12; H04L 12/761; H04L 12/18; H04B 17/309

(52) U.S. Cl. CPC H04H 20/08; H04L 12/18; H04B 17/309; H04W 40/12; H04L 45/16; H04W 8/14; H04W 88/04

(57) ABSTRACT

The present invention relates to a transmission method and system for groupcast message and a storage medium accessible by electronic devices applicable to a first electronic device transmitting a groupcast message to a plurality of remote second electronic devices. The method comprises steps of: acquiring a piece of communication quality information for each said second electronic device and each said piece of communication quality information representing the connection quality between each said second electronic device and nearby devices; the first electronic device selecting one of the plurality of second electronic devices as a broadcast transmitter according to the plurality pieces of communication quality information; the first electronic device transmitting the groupcast message to the broadcast transmitter; and the broadcast transmitter transmitting a broadcast message to the plurality of second electronic devices. Thereby, transmission of a groupcast message to the second electronic devices can be ensured without adding extra transmission cost.

### FIELD OF THE INVENTION

The present invention relates generally to communication, and particularly to a transmission method and system for groupcast message to a plurality of remote electronic devices, and to a storage medium accessible by electronic devices.

### BACKGROUND OF THE INVENTION

As the Internet is developing rapidly, the technology of Internet of Things (IoT) attracts attention increasingly and is applied to various fields in people's everyday lives.

The IoT is a network based the Internet and enabling physical entities therein having networking capability to communicate with one another. In the IoT, each physical entity can be accessed or manipulated through the network. Equipment, machines, and articles can be managed and manipulated concentrically via the IoT. Its application range is very extensive, such as smart living environment, health and medical, and burglarproof applications.

The methods for manipulating physical entities in the IoT can be categorized into two types. The first is to command the physical entities to be manipulated directly. If the client commands a physical entity inside the IoT, direct manipulation is an easily achievable method. Nonetheless, as the client is at a remote site and wishes to manipulate the physical entity in the IoT, the manipulation command needs to be delivered via the network media. If the physical entity is disposed nearby the network media, the manipulation command submitted by the client can certainly be delivered smoothly. Unfortunately, if the physical entity is disposed so remote to the network media that the manipulation command cannot be delivered via the network media, the second type of method should be adopted for delivering the manipulation command.

The second type of method for manipulating physical entities in the IoT is to transmit groupcast messages containing manipulation command to all the physical entities in the IoT. This transmission method is that the client's electronic device selects randomly a physically entity in the IoT and transmits a groupcast message containing a manipulation command to the selected physical entity through the network media. Then the physical entity transmits the manipulation command to the other physical entities.

Nonetheless, according to this type of method, a physical entity in the IoT is selected randomly as the transmitter of the groupcast message. Under random selection, if the selected physical entity has inferior connection quality, errors in the groupcast message might result during the transmission process owing to the bad connection quality. In order to make sure the groupcast message is received by the selected physical entity, mechanisms such as the fault detection, the error correction, and the re-transmission of the groupcast message must be included when this method is applied, resulting in extra costs. In some severe cases, because the groupcast messages are re-transmitted continuously, the groupcast messages are jammed between the network media and the transmitter, disabling the groupcast message to be delivered with certainty.

Accordingly, how to transmit a groupcast message to a physical entity in the IoT with certainty without increasing extra transmission costs has become a major subject in the present day.

### SUMMARY

An objective of the present invention is to provide a transmission method and system for groupcast message and a storage medium accessible by electronic devices, which can transmit groupcast messages to remote electronic devices without increasing extra transmission costs.

In order to achieve the above objective and efficacy, according to an embodiment of the present invention, a transmission method for groupcast message is disclosed and applicable to a first electronic device transmitting a groupcast message to a plurality of remote second electronic devices. The method comprises steps of: acquiring a piece of communication quality information for each said second electronic device and each said piece of communication quality information representing the connection quality between each said second electronic device and nearby devices; the first electronic device selecting one of the plurality of second electronic devices as a broadcast transmitter according to the plurality pieces of communication quality information; the first electronic device transmitting the groupcast message to the broadcast transmitter; and the broadcast transmitter transmitting a broadcast message to the plurality of second electronic devices.

Furthermore, according to another embodiment of the present invention, a transmission system for groupcast message is disclosed and applicable to transmitting a groupcast message to a plurality of remote second electronic devices. The transmission system comprises a first electronic device and a plurality of second electronic devices. The first electronic device transmits a groupcast message. Each said second electronic device includes a piece of communication quality information representing the connection quality between each said second electronic device and nearby devices. The first electronic device selects one of the plurality of second electronic devices as a broadcast transmitter according to the plurality pieces of communication quality information. The first electronic device transmits the groupcast message to the broadcast transmitter. The broadcast transmitter transmits a broadcast message to the plurality of second electronic devices.

Moreover, according another embodiment of the present invention, a storage medium accessible by electronic devices is disclosed. A program is stored in the storage medium accessible by electronic devices and used for executing a transmission method for groupcast message. The method is applicable to a first electronic device transmitting a groupcast message to a plurality of remote second electronic devices. The method comprises steps of: acquiring a piece of communication quality information for each of said plurality of second electronic devices and each said piece of communication quality information representing the connection quality between each of said plurality of said second electronic devices and nearby devices; the first electronic device selecting one of the plurality of second electronic devices as a broadcast transmitter according to the plurality pieces of communication quality information; the first electronic device transmitting the groupcast message to the broadcast transmitter; and the broadcast transmitter transmitting a broadcast message to the plurality of second electronic devices.

### BRIEF DESCRIPTION OF THE DRAWINGS

FIG. 1A shows a schematic diagram of the first electronic device acquiring the information of each second electronic device via the medium according to the first embodiment of the present invention;

FIG. 1B shows a schematic diagram of the first electronic device acquiring the information of each second electronic device via the medium according to the second embodiment of the present invention;

FIG. 1C shows a schematic diagram of the transmission method for groupcast message according to the first embodiment of the present invention;

FIG. 2 shows a flowchart of the transmission method for groupcast message according to the first embodiment of the present invention;

FIG. 3 shows a schematic diagram of defining groups according to an embodiment of the present invention;

FIG. 4A shows a schematic diagram of the transmission system for groupcast message according to the second embodiment of the present invention;

FIG. 4B to 4D show schematic diagrams of the transmission method for groupcast message according to the second embodiment of the present invention; and

FIG. 5 shows a flowchart of the transmission method for groupcast message according to the second embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

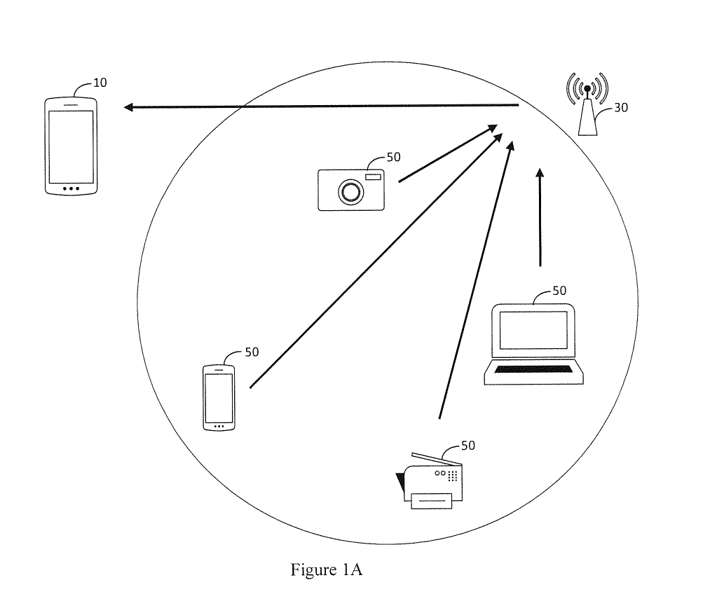

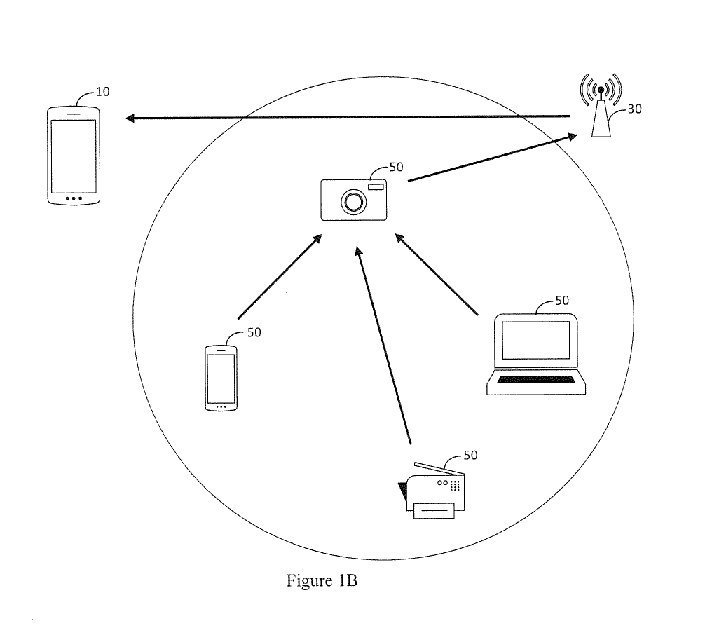

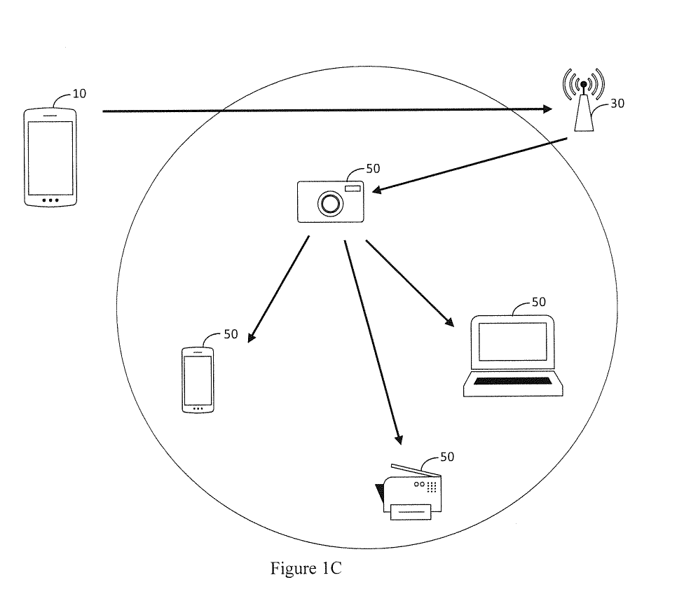

Please refer to FIG. 1A. As shown in the figure, the present embodiment provides a transmission system for groupcast message 1, which comprises a first electronic device 10, a medium 30, and a plurality of second electronic devices 50. According to the present embodiment, the first electronic device 10 and the plurality of second electronic devices 50 transmit information via the medium 30.

The first electronic device 10 according to the present embodiment includes a smartphone, a personal digital assistant (PDA), a tablet computer, a notebook computer, a desktop computer, or other electronic devices capable of transmitting information.

The plurality of second electronic devices 50 according to the present invention include smartphones, PDAs, tablet computers, notebook computers, desktop computers, webcams, smart plugs, or other electronic devices capable of transmitting information. In addition, each of the plurality of second electronic devices 50 includes a connecting unit, respectively and is capable of connecting to one another through the respective connecting unit. The connecting unit includes infrared, Bluetooth, ZigBee, Wi-Fi, or physical networks.

The medium 30 according to the present embodiment includes a router, a switch, a hub, a cloud server, a relay, or other media capable of network transmission.

The transmission system 1 according to the present embodiment is used in transmitting a groupcast message to a plurality of second electronic devices 50 by the first electronic device 10 for controlling or configuring the plurality of second electronic devices 50 or transmitting data to the plurality of second electronic devices 50. For example, the first electronic device 10 according to the present embodiment is a smartphone while the plurality of second electronic devices 50 are smart appliances. When a user operates the first electronic device 10 and transmits a control signal to the plurality of second electronic devices 50, the signal can be transmitted using the transmission method and system 1 for groupcast message disclosed in the present embodiment.

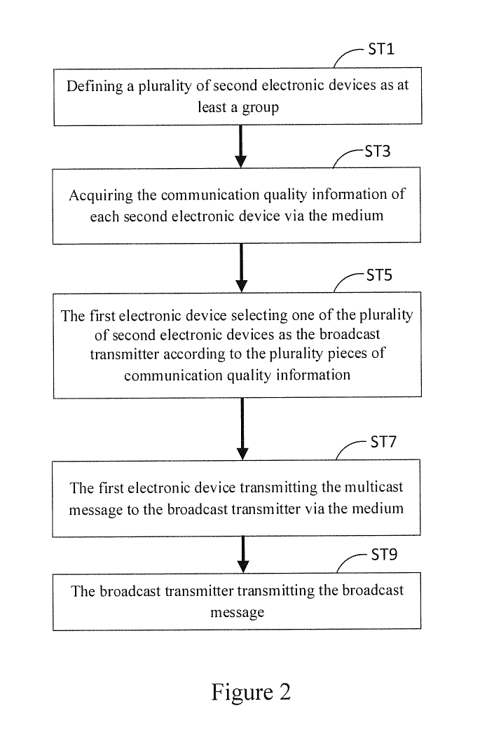

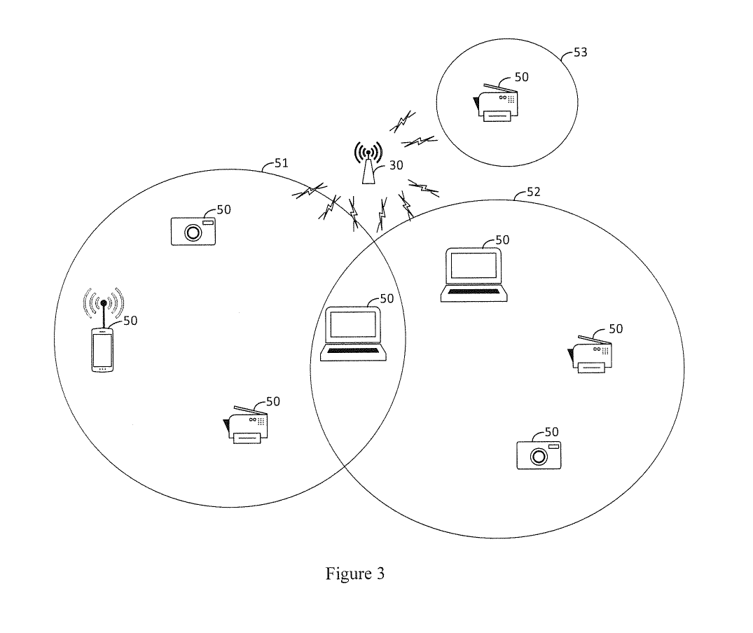

Please refer to FIGS. 1A, 1B, 1C, 2. As shown in the figures, when the transmission system 1 according to the present embodiment operates, the step ST1 is first executed for defining the plurality of second electronic device 50 as at least one group. According to the present embodiment, the plurality of second electronic devices 50 are configured to the same group. According to another embodiment of the present invention, the plurality of second electronic devices 50 are defined to multiple groups. As shown in FIG. 3, each group includes at least one second electronic device 50. The second electronic devices in the same group can transmit information to one another; the electronic devices 50 in different groups can also transmit information. The first electronic device can transmit a groupcast message to one of the groups or a plurality of groups. As shown in FIG. 3, the group 51 and the group 52 are groups including a plurality of second electronic devices 50. On the other hand, the group 53 is a groups including only one second electronic device 50.

After the step ST1 is finished, the step ST3 is executed, in which the first electronic device 10 acquires the communication quality information of each of said plurality of second electronic devices 50 via the medium 30. The communication quality information represents the connection quality between each said second electronic device 50 and a nearby device, which includes another second electronic device 50 and the medium 30. The communication quality information includes the received signal strength indicator (RSSI) or the signal to noise ratio (SNR), representing the transmission intensity of the second electronic device 50. Each said second electronic device 50, as shown in FIG. 1A, can transmit the respective communication quality information to the first electronic device 10 through the medium 30. Alternatively, as shown in FIG. 1B, the first electronic device 50 assigns one of the plurality of second electronic devices 50 or the medium 30 as a relay terminal. Each said second electronic device 50 transmits respective communication quality information to the relay terminal. Then the relay terminal transmits the plurality pieces of communication quality information to the first electronic device 10.

Please refer again to FIG. 2. The step ST 5 is executed, in which the first electronic device 10 selects one of the plurality of second electronic devices 50 as the broadcast transmitter. The method by which the first electronic device 10 selects the broadcast transmitter is to select the second electronic device 50 having the best connection quality as the broadcast transmitter according to the respective communication quality information of the plurality of second electronic devices 50. Besides, according to another embodiment of the present invention, the first electronic device 10 sets a threshold value. When the communication quality information of a plurality of second electronic devices 50 exceeds the threshold value, a second electronic device 50 is selected randomly as the broadcast transmitter. Next, the step ST7 is executed. As shown in FIG. 1C, the first electronic device 10 transmits a groupcast message to the broadcast transmitter via the medium 30. The broadcast transmitter receives the groupcast message. The groupcast message described above includes the control signal transmitted by the first electronic device 10. The first electronic device 10 transmits the groupcast message to the broadcast transmitter based on TCP or UDP.

Please refer again to FIG. 2. Finally, the step ST9 is executed, in which the broadcast transmitter transmits a broadcast message according to the received groupcast message to the plurality of second electronic devices 50, as shown in FIG. 1C. The content of the broadcast message includes the groupcast message, namely, the control signal transmitted by the first electronic device 10. According to the above, the present embodiment provides a transmission method and system for groupcast message. The second electronic device having the best connection quality or connection quality exceeding the threshold value is the broadcast transmitter. Thereby, the device having superior transmission quality is used for transmitted messages, and thus ensuring that the messages can be delivered to the plurality of second electronic devices 50.

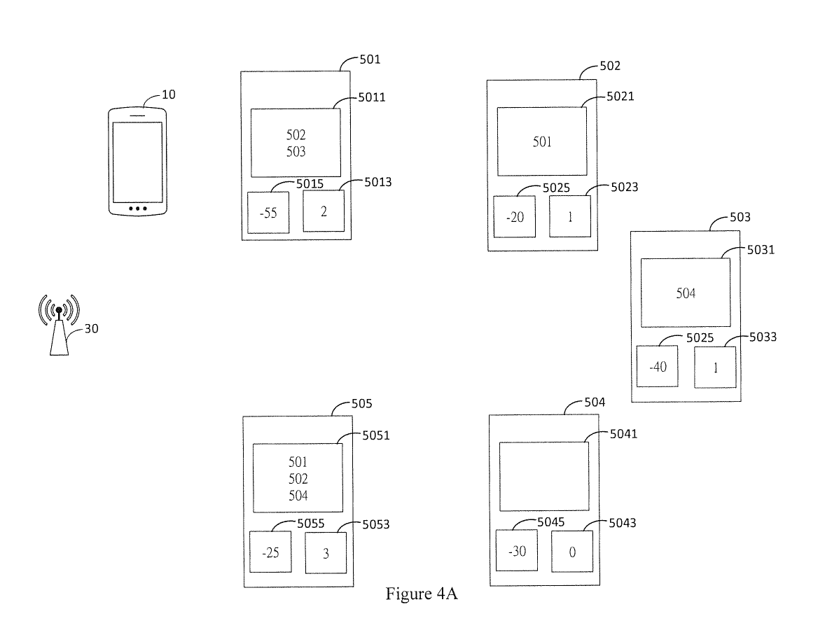

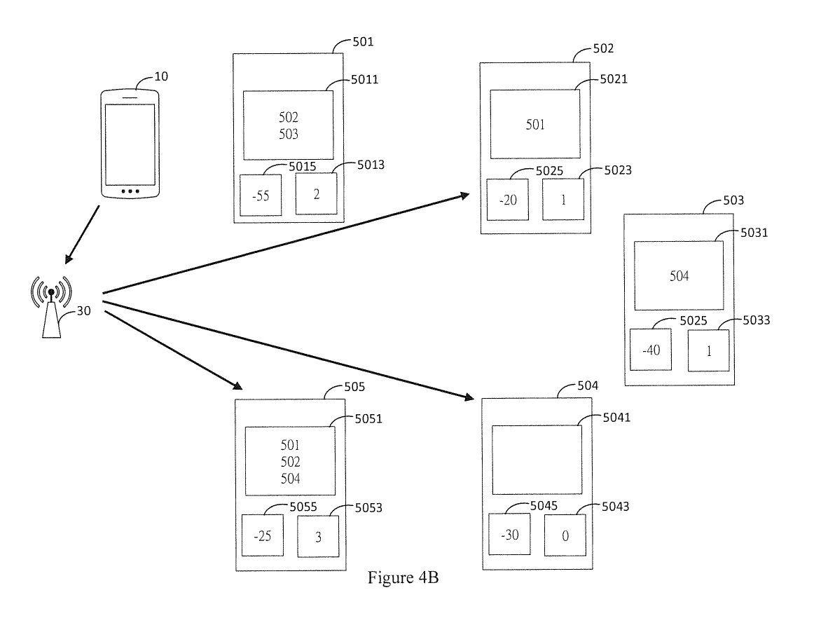

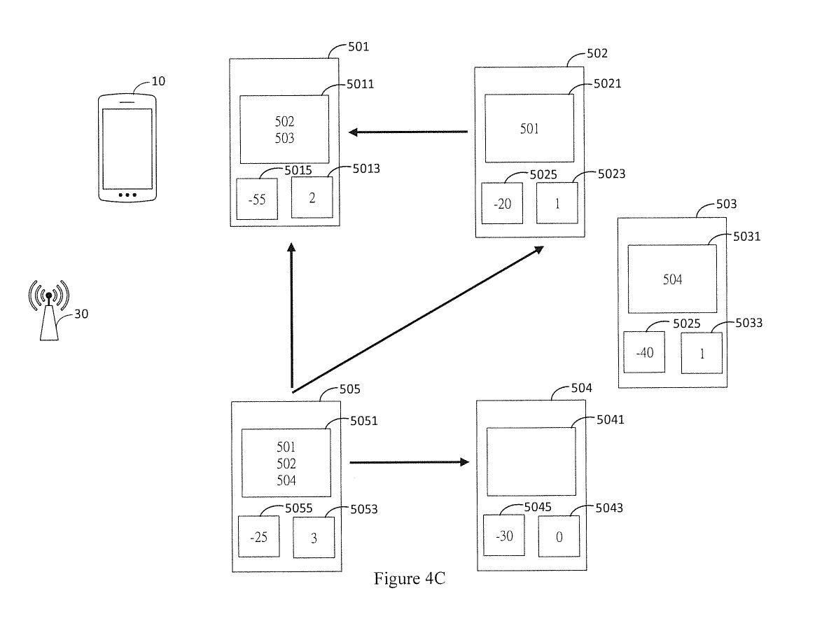

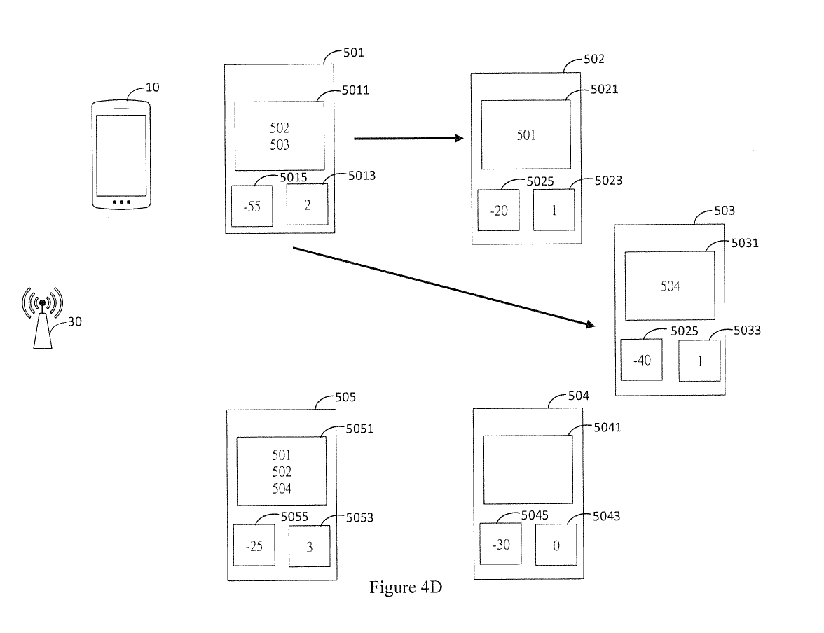

Next, the transmission method for groupcast message according to another embodiment will be described. Please refer to FIG. 4A. As shown in the figure, the embodiment provides another transmission system 2, which comprises a first electronic device 10, a medium 30, a plurality of second electronic devices 501, 502, 503, 504, 505. According to the present embodiment, the second electronic device 501 includes a neighborhood table 5011, a neighborhood quantity 5013, and a piece of communication quality information 5015. The neighborhood table 5011 records the other second electronic devices nearby the second electronic device 501. The neighborhood quantity represents the quantity of the other second electronic device nearby the second electronic device 501. The communication quality information is the connection quality between the second electronic device 501 and the nearby devices, including the communication quality between the second electronic device 501 and the medium 30.

Please refer again to FIG. 4A. The second electronic device 502 includes a neighborhood table 5021, a neighborhood quantity 5023, and a piece of communication quality information 5025. The neighborhood table 5021 records the other second electronic devices nearby the second electronic device 502. The neighborhood quantity 5023 represents the quantity of the other second electronic devices nearby the second electronic device 502. The communication quality information 5025 is the connection quality between the second electronic devices 502 the nearby other electronic devices and includes the communication quality between the second electronic device 502 and the medium 30. As the above description, the rest second electronic devices 503, 504, 505 also include neighboring tables 5031, 5041, 5051, neighboring quantities 5033, 5043, 5053, and communication quality information 5035, 5045, 5055. Each of the above second electronic devices 501, 502, 503, 504, 505 searches the nearby devices (including the second electronic devices and the medium 30) at startup, records them in the respective neighboring table 5011, 5012, 5031, 5041, 5051, and records the quantities of nearby devices.

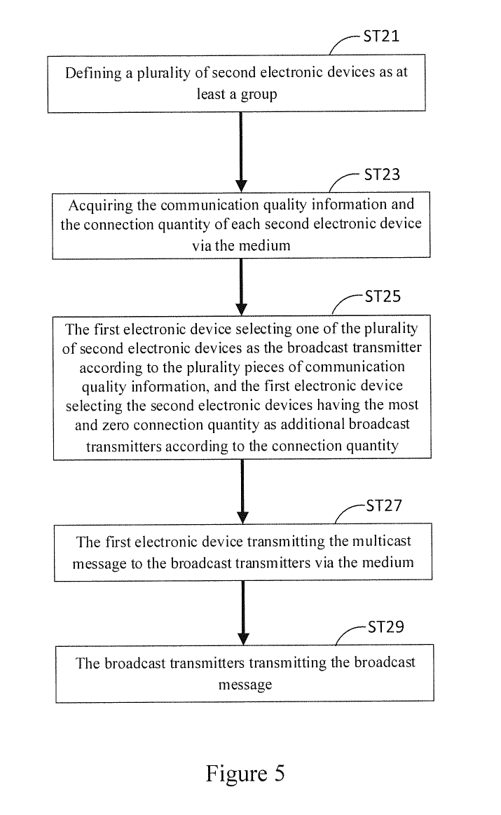

Please refer to FIG. 5 as well as FIGS. 4B-4D. When the transmission system 2 according to the present embodiment is operating, the step ST21 is first executed for defining the plurality of second electronic devices 50 to at least one group. According to the present embodiment, the plurality of second electronic devices 501, 502, 503, 504, 505 belong to one group.

After the step ST21 is completed, the step ST23 is executed, in which the first electronic device 10 acquires respective communication quality information 5015˜5055 and neighboring quantities 5013˜5053 of each of the second electronic devices 501, 502, 503, 504, 505. Then the step ST 25 is executed, in which the first electronic device selects one of the plurality of second electronic devices 501, 502, 503, 504, 505 as the broadcast transmitter. The method by which the first electronic device 10 selects the broadcast transmitter is based on the respective communication quality information of each of the second electronic devices 501, 502, 503, 504, 505. The one having the best connection quality is selected as the broadcast transmitter. According to the present embodiment, the communication quality information 5015˜5055 of the plurality of second electronic devices 501, 502, 503, 504, 505 is the RSSI having the values −55 dBm, −20 dBm, −40 dBm, −30 dBm, −25 dBm, respectively. The second electronic device 502 owns the best connection quality. Consequently, the first electronic device 10 selects the second electronic device 502 as the broadcast transmitter.

In addition, the first electronic device 10 further selects the second electronic device having the most neighboring quantity according to the respective neighboring quantities 5012˜5053 of the plurality of second electronic devices 501, 502, 503, 504, 505 as another broadcast transmitter. According to the present embodiment, the neighboring quantities 5013˜5053 of the plurality of second electronic devices 501, 502, 503, 504, 505 are 2, 1, 1, 0, 3, respectively. Hence, the neighboring quantity 5053 of the second electronic device 505 is the most, meaning that the second electronic device 505 has the most nearby second electronic devices. Then, the first electronic device 10 selects the second electronic device 505 as the broadcast transmitter.

Besides, the plurality of second electronic device may have no neighboring quantity, for example, when the second electronic device is placed at remote places such as the balcony or the roof. This means that this second electronic device cannot transmit information with the other electronic devices. In order to make sure that the broadcast signal is transmitted to each second electronic device, as shown in the step ST 25, the first electronic device 10 further selects the second electronic device having no neighboring as another broadcast transmitter. According to the present embodiment, the first electronic device 10 further selects the second electronic device 504 as another broadcast transmitter.

Please refer again to FIG. 5. Next, the step ST27 is executed. As shown in FIG. 4B, the first electronic device 10 transmits the groupcast message to the plurality of broadcast transmitters 502, 504, 505 via the medium 30. The plurality of broadcast transmitters 502, 504, 505 receive the groupcast message. Finally, the step ST29 is executed, in which the plurality of second electronic devices 502, 504, 505 (the broadcast transmitters) transmit a broadcast message according to the groupcast message. The content of the broadcast message includes the content of the groupcast message and the respective neighboring table of each of the broadcast transmitters. In other words, the broadcast message transmitted by the plurality of second electronic device 502, 504, 505 include the content of the groupcast message and the respective neighboring tables 5021, 5041, 5051. The plurality of second electronic device 502, 504, 505 transmit the broadcast message according to the respective neighboring tables 5021, 5041, 5051. As shown in FIG. 4C, the second electronic device 502 transmits the broadcast message to the second electronic device 501 according to the neighboring table 5021. The neighboring table 5041 of the second electronic device 504 does not record the nearby second electronic devices. Thereby, the second electronic device 504 does not transmit the broadcast message any longer. The broadcast transmitter 505 transmits the broadcast message to the second electronic devices 501, 502, 504 according to the neighboring table 5051.

Moreover, the plurality of second electronic devices having received the broadcast message will compare their own neighboring tables with those of the broadcast transmitters. When their own neighboring tables include the second electronic device not recorded in the neighboring tables of the broadcast transmitters, they will transmit the received broadcast message according to their own neighboring tables. As shown in FIG. 4D, when the second electronic device 501 receives the broadcast messages transmitted by the plurality of second electronic devices 502, 505 (the broadcast transmitters), the second electronic device 501 compares the neighboring tables 5021, 5051 in the broadcast messages. According to the present embodiment, both the neighboring tables 5021, 5051 do not include the second electronic device 503 recorded in the neighboring table 5011 of the second electronic device 501. Thereby, as shown in FIG. 4D, the second electronic device 501 transmits the received broadcast message to the second electronic device 503 according to its own neighboring table 5011, and thus ensuring that the broadcast can be transmitted to all second electronic devices.

The transmission method for groupcast message according to the present invention can be implemented as a program and stored in a storage medium accessible by an electronic device. Thereby, after the electronic device reads the storage medium, the transmission method for groupcast message is executed. A computer accessible storage medium can be a read-only memory, a flash memory, a floppy disk. A hard disk, a compact disk, a USB flash drive, a magnetic tape, a network accessible database, or any other storage medium accessible by electronic devices well known to a personal having ordinary skill in the art.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. A transmission method for groupcast message, applicable to a first electronic device transmitting a groupcast message to a plurality of second electronic devices, comprising steps of:
acquiring a piece of communication quality information for each said second electronic device and each said piece of communication quality information representing the connection quality between each said second electronic device and nearby devices;
said first electronic device selecting one of said plurality of second electronic devices as a broadcast transmitter according to said plurality pieces of communication quality information;
said first electronic device transmitting said groupcast message to said broadcast transmitter; and
said broadcast transmitter transmitting a broadcast message according to said received groupcast message to said plurality of second electronic devices.

2. The transmission method for groupcast message of claim 1, wherein said first electronic device selects said second electronic device having the best connection quality as said broadcast transmitter according to said plurality pieces of communication quality information.

3. The transmission method for groupcast message of claim 1, wherein each of said second electronic devices includes a neighboring table, respectively, recording nearby other second electronic devices of said second electronic device; said broadcast message transmitted by said broadcast transmitter includes said neighboring table of said broadcast transmitter; after said second electronic device receives said broadcast message transmitted by said broadcast transmitter, said second electronic device compares its own neighboring table with said neighboring table of said broadcast transmitter; and when its own neighboring table includes said second electronic device not recorded in said neighboring table of said broadcast transmitter, said second electronic device transmits said received broadcast message according to its own neighboring table.

4. The transmission method for groupcast message of claim 3, and further comprising a step of each of said second electronic devices searching nearby other second electronic devices and recording in said neighboring table.

5. The transmission method for groupcast message of claim 1, wherein each of said second electronic devices records the neighboring quantity of the nearby second electronic devices of said second electronic device, respectively; each of said second electronic devices transmits said neighboring quantity, respectively; said first electronic device selects said second electronic device having zero neighboring quantity as another broadcast transmitter according to said neighboring quantities for receiving said groupcast message transmitted by said first electronic device and transmitting said broadcast message.

6. The transmission method for groupcast message of claim 1, wherein each of said second electronic devices records the neighboring quantity of the nearby second electronic devices of said second electronic device, respectively; each of said second electronic devices transmits said neighboring quantity, respectively; said first electronic device selects said second electronic device having the most neighboring quantity as another broadcast transmitter according to said neighboring quantities for receiving said groupcast message transmitted by said first electronic device and transmitting said broadcast message.

7. The transmission method for groupcast message of claim 5, and further comprising a step of assigning one of said plurality of second electronic devices as a relay terminal, each of said second electronic devices transmitting said neighboring quantity to said relay terminal, respectively, and said relay terminal transmitting said neighboring quantities to said first electronic device.

8. The transmission method for groupcast message of claim 6, and further comprising a step of assigning one of said plurality of second electronic devices as a relay terminal, each of said second electronic devices transmitting said neighboring quantity to said relay terminal, respectively, and said relay terminal transmitting said neighboring quantities to said first electronic device.

9. The transmission method for groupcast message of claim 1, and further comprising a step of assigning one of said plurality of second electronic devices as a relay terminal, each of said second electronic devices transmitting said communication quality information to said relay terminal, respectively, and said relay terminal transmitting said plurality pieces of communication quality information to said first electronic device.

10. The transmission method for groupcast message of claim 1, and further comprising a step of defining said plurality of second electronic devices as at least a group.

11. The transmission method for groupcast message of claim 1, wherein said first electronic device and said plurality of second electronic devices transmit information via a medium.

12. The transmission method for groupcast message of claim 1, wherein said communication quality information is a received signal strength indicator or a signal to noise ratio.

13. A transmission system for groupcast message, applicable to transmitting a groupcast message to a plurality of remote devices, comprising:
a first electronic device, transmitting said groupcast message; and
a plurality of second electronic devices, each of said second electronic devices including a piece of communication quality information, respectively, representing the connection quality between each of said second electronic devices and nearby devices;
where said first electronic device selects one of said plurality of second electronic devices as a broadcast transmitter according to said plurality pieces of communication quality information; said first electronic device transmits said groupcast message to said broadcast transmitter; and said broadcast transmitter transmits a broadcast message according to said received groupcast message to said plurality of second electronic devices.

14. The transmission system for groupcast message of claim 13, wherein said first electronic device selects said second electronic device having the best connection quality as said broadcast transmitter according to said plurality pieces of communication quality information.

15. The transmission system for groupcast message of claim 13, wherein each of said second electronic devices includes a neighboring table, respectively, recording nearby other second electronic devices of said second electronic device; said broadcast message transmitted by said broadcast transmitter includes said neighboring table of said broadcast transmitter; after said second electronic device receives said broadcast message transmitted by said broadcast transmitter, said second electronic device compares its own neighboring table with said neighboring table of said broadcast transmitter; and when its own neighboring table includes said second electronic device not recorded in said neighboring table of said broadcast transmitter, said second electronic device transmits said received broadcast message according to its own neighboring table.

16. The transmission system for groupcast message of claim 15, wherein each of said second electronic devices searches nearby other second electronic devices and records in said neighboring table.

17. The transmission system for groupcast message of claim 13, wherein each of said second electronic devices records the neighboring quantity of the nearby second electronic devices of said second electronic device, respectively; each of said second electronic devices transmits said neighboring quantity, respectively; said first electronic device selects said second electronic device having zero neighboring quantity as another broadcast transmitter according to said neighboring quantities for receiving said groupcast message transmitted by said first electronic device and transmitting said broadcast message.

18. The transmission system for groupcast message of claim 13, wherein each of said second electronic devices records the neighboring quantity of the nearby second electronic devices of said second electronic device, respectively; each of said second electronic devices transmits said neighboring quantity, respectively; said first electronic device selects said second electronic device having the most neighboring quantity as another broadcast transmitter according to said neighboring quantities for receiving said groupcast message transmitted by said first electronic device and transmitting said broadcast message.

19. The transmission system for groupcast message of claim 15, wherein one of said plurality of second electronic devices is a relay terminal; each of said second electronic devices transmits said neighboring quantity to said relay terminal, respectively; and said relay terminal transmits said neighboring quantities to said first electronic device.

20. The transmission system for groupcast message of claim 16, wherein one of said plurality of second electronic devices is a relay terminal; each of said second electronic devices transmits said neighboring quantity to said relay terminal, respectively; and said relay terminal transmits said neighboring quantities to said first electronic device.

21. The transmission system for groupcast message of claim 13, wherein one of said plurality of second electronic devices is a relay terminal; each of said second electronic devices transmits said communication quality information to said relay terminal, respectively; and said relay terminal transmits said plurality pieces of communication quality information to said first electronic device.

22. The transmission system for groupcast message of claim 13, wherein said plurality of second electronic devices form at least a group.

23. The transmission system for groupcast message of claim 13, wherein said first electronic device and said plurality of second electronic devices transmit information via a medium.

24. The transmission system for groupcast message of claim 13, wherein said communication quality information is a received signal strength indicator or a signal to noise ratio.

25. A tangible storage medium accessible by electronic devices, storing a non-transitory program, used for executing a transmission method for groupcast message applicable to a first electronic device transmitting a groupcast message to a plurality of second electronic devices, and said method comprising steps of:
acquiring a piece of communication quality information for each said second electronic device and each said piece of communication quality information representing the connection quality between each said second electronic device and nearby devices;
said first electronic device selecting one of said plurality of second electronic devices as a broadcast transmitter according to said plurality pieces of communication quality information;
said first electronic device transmitting said groupcast message to said broadcast transmitter; and
said broadcast transmitter transmitting a broadcast message according to said received groupcast message to said plurality of second electronic devices.

26. The tangible storage medium accessible by electronic devices storing a non-transitory program of claim 25, wherein said first electronic device selects said second electronic device having the best connection quality as said broadcast transmitter according to said plurality pieces of communication quality information.

27. The tangible storage medium accessible by electronic devices storing a non-transitory program of claim 25, wherein each of said second electronic devices includes a neighboring table, respectively, recording nearby other second electronic devices of said second electronic device; said broadcast message transmitted by said broadcast transmitter includes said neighboring table of said broadcast transmitter; after said second electronic device receives said broadcast message transmitted by said broadcast transmitter, said second electronic device compares its own neighboring table with said neighboring table of said broadcast transmitter; and when its own neighboring table includes said second electronic device not recorded in said neighboring table of said broadcast transmitter, said second electronic device transmits said received broadcast message according to its own neighboring table.

28. The tangible storage medium accessible by electronic devices storing a non-transitory program of claim 27, and further comprising a step of each of said second electronic devices searching nearby other second electronic devices and recording in said neighboring table.

29. The tangible storage medium accessible by electronic devices storing a non-transitory program of claim 25, wherein each of said second electronic devices records the neighboring quantity of the nearby second electronic devices of said second electronic device, respectively; each of said second electronic devices transmits said neighboring quantity, respectively; said first electronic device selects said second electronic device having zero neighboring quantity as another broadcast transmitter according to said neighboring quantities for receiving said groupcast message transmitted by said first electronic device and transmitting said broadcast message.

30. The tangible storage medium accessible by electronic devices storing a non-transitory program of claim 25, wherein each of said second electronic devices records the neighboring quantity of the nearby second electronic devices of said second electronic device, respectively; each of said second electronic devices transmits said neighboring quantity, respectively; said first electronic device selects said second electronic device having the most neighboring quantity as another broadcast transmitter according to said neighboring quantities for receiving said groupcast message transmitted by said first electronic device and transmitting said broadcast message.

31. The tangible storage medium accessible by electronic devices storing a non-transitory program of claim 29, and further comprising a step of assigning one of said plurality of second electronic devices as a relay terminal, each of said second electronic devices transmitting said neighboring quantity to said relay terminal, respectively, and said relay terminal transmitting said neighboring quantities to said first electronic device.

32. The tangible storage medium accessible by electronic devices storing a non-transitory program of claim 30, and further comprising a step of assigning one of said plurality of second electronic devices as a relay terminal, each of said second electronic devices transmitting said neighboring quantity to said relay terminal, respectively, and said relay terminal transmitting said neighboring quantities to said first electronic device.

33. The tangible storage medium accessible by electronic devices storing a non-transitory program of claim 25, and further comprising a step of assigning one of said plurality of second electronic devices as a relay terminal, each of said second electronic devices transmitting said communication quality information to said relay terminal, respectively, and said relay terminal transmitting said plurality pieces of communication quality information to said first electronic device.

34. The tangible storage medium accessible by electronic devices storing a non-transitory program of claim 25, and further comprising a step of defining said plurality of second electronic devices as at least a group.

35. The tangible storage medium accessible by electronic devices storing a non-transitory program of claim 25, wherein said first electronic device and said plurality of second electronic devices transmit information via a medium.

36. The tangible storage medium accessible by electronic devices storing a non-transitory program of claim 25, wherein said communication quality information is a received signal strength indicator or a signal to noise ratio.
